(19) United States
(12) Patent Application Publication
(10) Pub. No.: US 2014/0168460 A1
(43) Pub. Date: Jun. 19, 2014

(54) ELECTRONIC DEVICE AND IMAGE CAPTURING CONTROL METHOD

(71) Applicant: HON HAI PRECISION INDUSTRY CO. LTD., New Taipei (TW)

(72) Inventor: CHIH-YUAH TSAI, New Taipei (TW)

(73) Assignee: HON HAI PRECISION INDUSTRY CO., LTD., New Taipei (TW)

(21) Appl. No.: 14/097,250

(22) Filed: Dec. 5, 2013

(30) Foreign Application Priority Data
Dec. 13, 2012 (TW) 101147293

(51) Int. Cl. H04N 5/232

(52) U.S. Cl. CPC H04N 5/23219
USPC 348/222.1

(57) ABSTRACT

In a method for capturing an optimized image of people jumping, the method obtains a first image captured by an image capturing device of an electronic device, detecting face areas from the first image, obtains vertical coordinates of center points of the detected face areas, and calculates an average value of the vertical coordinates of the center points. The method further controls the image capturing device to capture a second image when the calculated average value is greater than a preset value, the second image is determined as the optimized image that all of people in the second image have jumped.

### BACKGROUND

1. Technical Field

Embodiments of the present disclosure relate to image capturing technology, and particularly to an electronic device and a method for capturing image of people jumping.

2. Description of Related Art

Digital cameras can be used to capture images of people jumping. To obtain a better image of the people jumping, one method is used to raise the shutter speed of the digital cameras, so that the images of people jumping are captured clearly. Another method is used to improve a performance of an automatic focus (AF) system of the digital cameras.

However, the above-mentioned two methods cannot capture an optimized image of people jumping, for example, someone is jumping while other people are not in the captured images. Therefore, a method for capturing an optimized image of people jumping is desired.

### BRIEF DESCRIPTION OF THE DRAWINGS

FIG. 1 is a block diagram of one embodiment of an electronic device including an image capturing control system.

FIG. 2 is a block diagram of function modules of the image capturing control system included in the electronic device.

FIG. 3 is a flowchart of one embodiment of a method for capturing an optimized image of people jumping.

FIG. 4 is a schematic diagram of a reference line which is preset on a display screen of the electronic device.

FIG. 5 is a schematic diagram of a plurality of face areas which are detected in a first image captured by an image capturing device of the electronic device.

FIG. 6 is a schematic diagram of an average value of Y-axis coordinates of center points of the detected face areas.

FIG. 7 and FIG. 8 are schematic diagrams of comparing the average value of the Y-axis coordinates in FIG. 6 with a preset Y-axis coordinate corresponding to the preset reference line in FIG. 4.

FIGS. 9-13 are schematic diagrams of operation steps for capturing an optimized image of people jumping.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

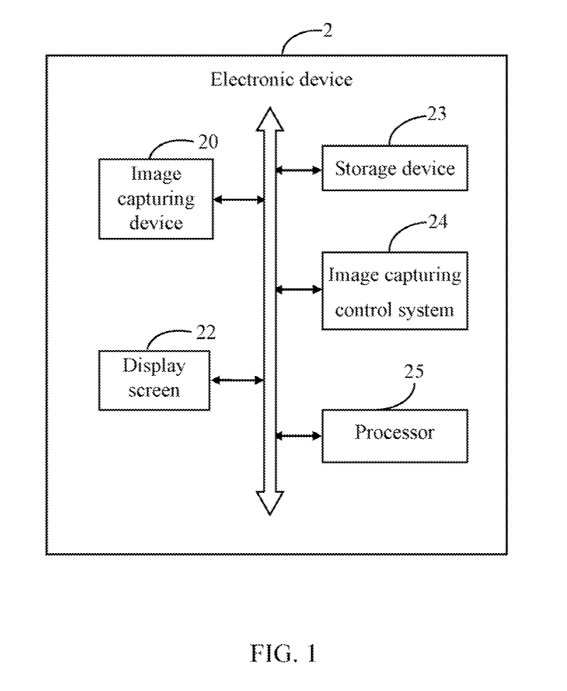

FIG. 1 is a block diagram of one embodiment of an electronic device 2 including an image capturing control system 24. The electronic device 2 further includes an image capturing device 20, a display screen 22, a storage device 23, and at least one processor 25. It should be understood that FIG. 1 illustrates only one example of the electronic device 2 that may include more or fewer components than illustrated, or a different configuration of the various components in other embodiments. In one embodiment, the electronic device 2 may be a desktop computer.

In one embodiment, the image capturing device 20 is used to capture images of a scene, and store the captured images in the storage device 23. For example, the image capturing device 20 may be an Internet Protocol (IP) camera, and the image capturing device 20 captures ten images per second (10 frames/s). That is to say, a capture interval of the image capturing device 20 is about 0.1 seconds.

The image capturing control system 24 is used to obtain a first image captured by the image capturing device 20, detect face areas from the first image, and obtain an optimized image of people jumping when all of people have jumped. In one embodiment, the image capturing control system 24 may include computerized instructions in the form of one or more programs that are executed by the processor 25 and stored in the storage device 23 (or memory). A detailed description of the image capturing control system 24 will be given in the following paragraphs.

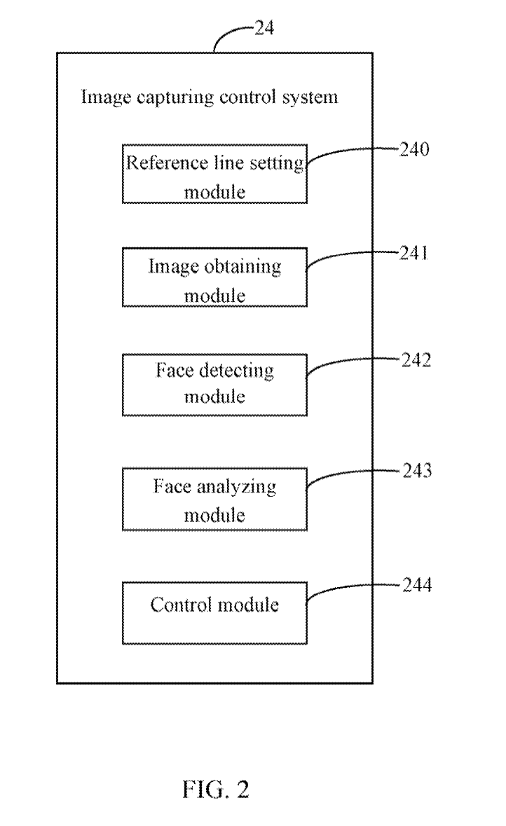

FIG. 2 is a block diagram of function modules of the image capturing control system 24 included in the electronic device 2. In one embodiment, the image capturing control system 24 may include one or more modules, for example, a reference line setting module 240, an image obtaining module 241, a face detecting module 242, a face analyzing module 243, and a control module 244. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

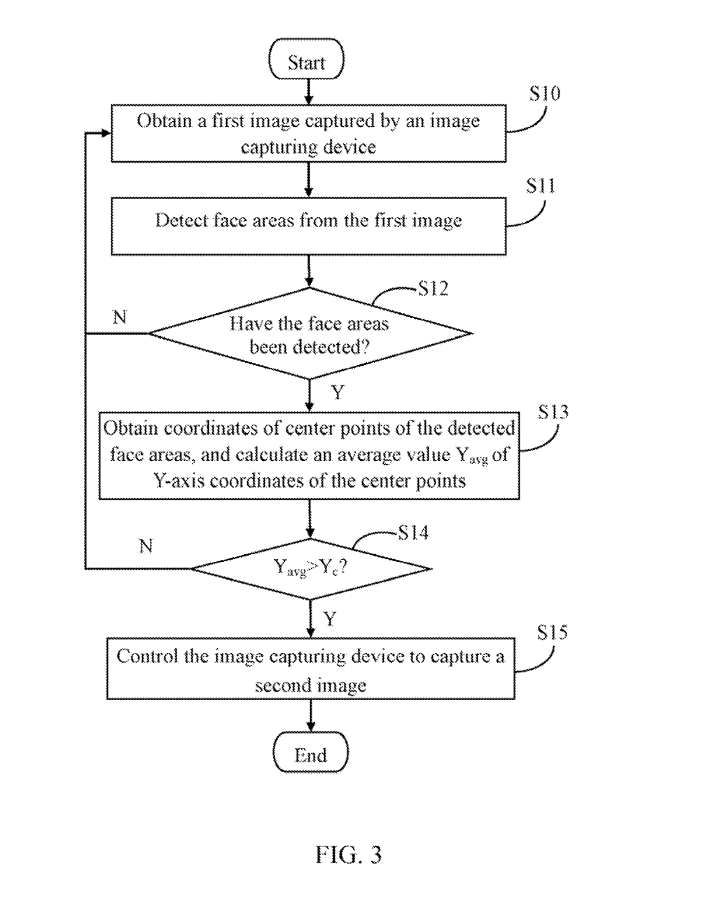

FIG. 3 is a flowchart of one embodiment of a method for capturing an optimized image of people jumping. Depending on the embodiment, additional steps may be added, others removed, and the ordering of the steps may be changed.

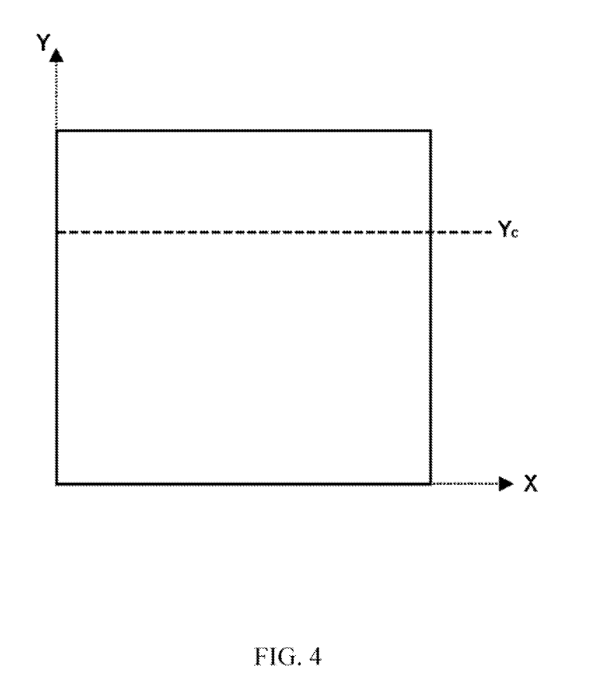

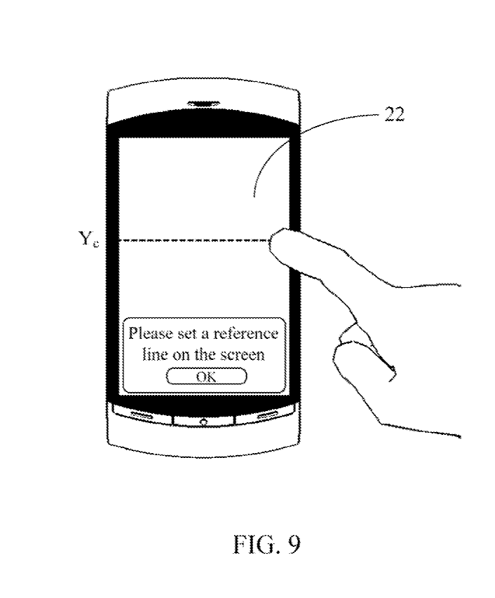

Before implementing the flow shown in FIG. 3, a reference line is preset on the display screen 22 using the reference line setting module 240 (refers to FIG. 9). As shown in FIG. 4, a rectangular area represents an image capturing range of the image capturing device 20. In one embodiment, a width of the display screen 22 is determined as an X-axis of the display screen 22 (e.g., an X-axis of the captured image), and a height of the display screen 22 is determined as a Y-axis of the display screen 22 (e.g., a Y-axis of the captured image). In one embodiment, the X-axis of display screen 22 represents a horizontal axis of the display screen 22, and the Y-axis of display screen 22 represents a vertical axis of the display screen 22. When the reference line is preset on the display screen 22, the reference line setting module 240 determines a Y-axis coordinate “Yc” of the reference line, and stores the Y-axis coordinate in the storage device 23. The Y-axis coordinate “Yc” of the reference line represents a height of the reference line on the display screen 22.

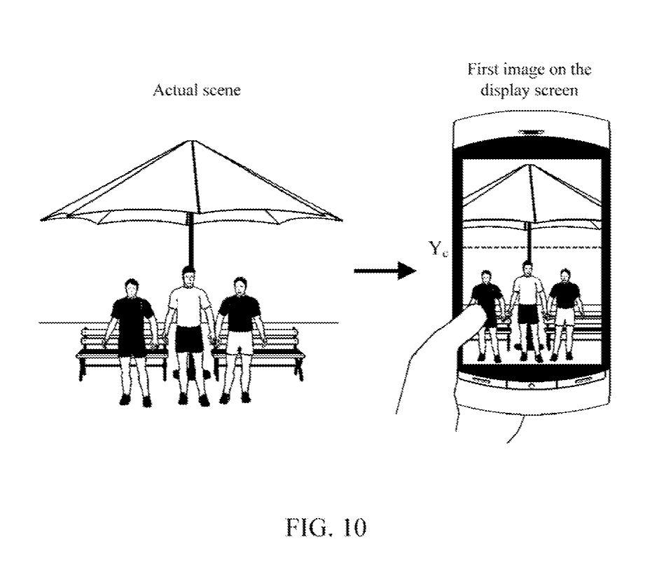

In step S10, the image obtaining module 241 obtains a first image of an actual scene captured by the image capturing device 20 at each preset time interval (e.g., one second). The first image is a real-time image captured by the image capturing device, an example of the first image is shown in FIG. 10.

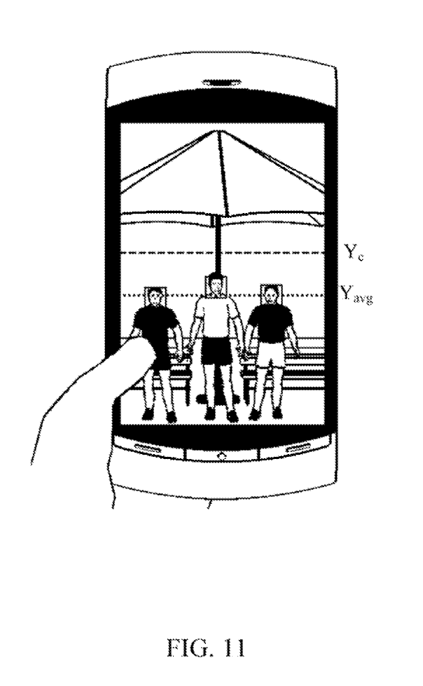

In step S11, the face detecting module 242 detects face areas from the first image (refers to FIG. 11). In one embodiment, the face detecting module 242 detects the face areas from the first image using an skin color model in YCbCr space or a face template matching method, or other suitable face detection methods. In one embodiment, the face area may be a smallest rectangle framing the face of the people in the first image.

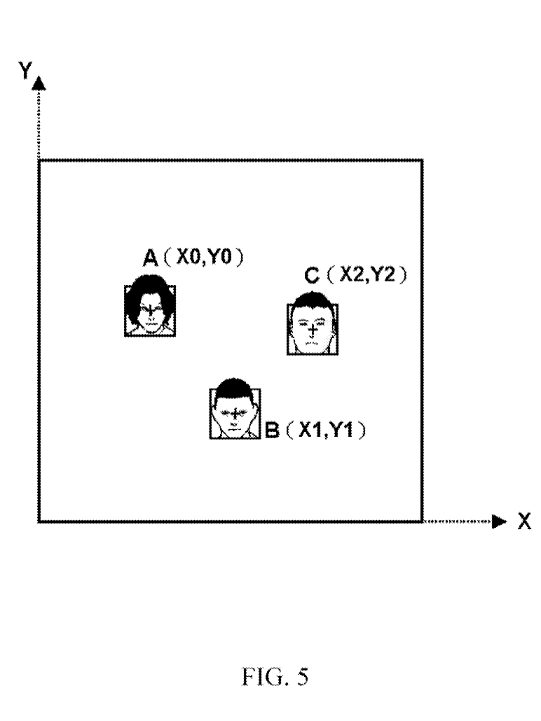

For example, as shown in FIG. 5, the face detecting module 242 detects three face areas “A”, “B”, and “C” from the first image, where the coordinates of the center point of the face area “A” are determined as “(X0, Y0)”, the coordinates of the center point of the face area “B” are determined as “(X1, Y1)”, and the coordinates of the center point of the face area “C” are determined as “(X2, Y2)”. In one embodiment, a Y-axis coordinate of the center point of the detected face area represents a Y-axis height of the detected face in the first image (i.e., a jumping height of the people).

In step S12, the face detecting module 242 determines whether the face areas have been detected from the first image. If one or more face areas have been detected from the first image, the procedure goes to step S13. If no face area has been detected from the first image, the procedure returns to step S10.

In step S13, the face analyzing module 243 obtains the coordinates (including the X-axis coordinates and the Y-axis coordinates) of the center points of the detected face areas, and calculates an average value “Y_{avg}” of the Y-axis coordinates of the center points (refers to FIG. 11).

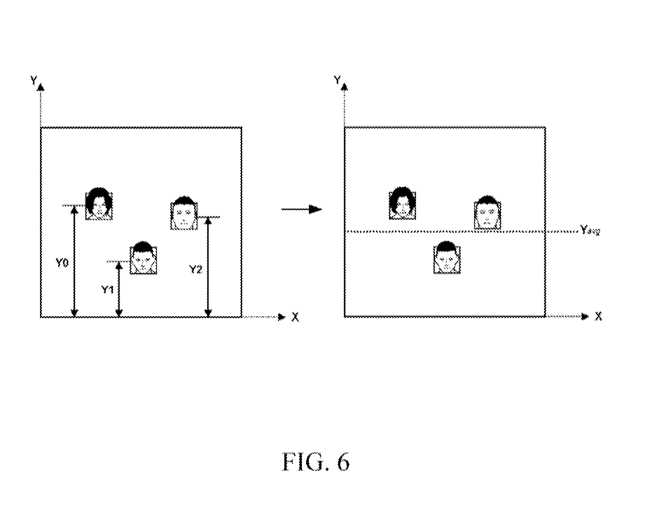

For example, as shown in FIG. 5, the face analyzing module 243 obtains a Y-axis coordinate “Y0” of the center point of the detected face area “A”, a Y-axis coordinate “Y1” of the center point of the detected face area “B”, and a Y-axis coordinate “Y2” of the center point of the detected face area “C”. Then, the face analyzing module 243 calculates the average value “Y_{avg}” of the Y-axis coordinates of the three center points according to a formula of “(Y0+Y1+Y2)/3”. An example of the average value “Y_{avg}” of the Y-axis coordinates of the three center points is shown in FIG. 6.

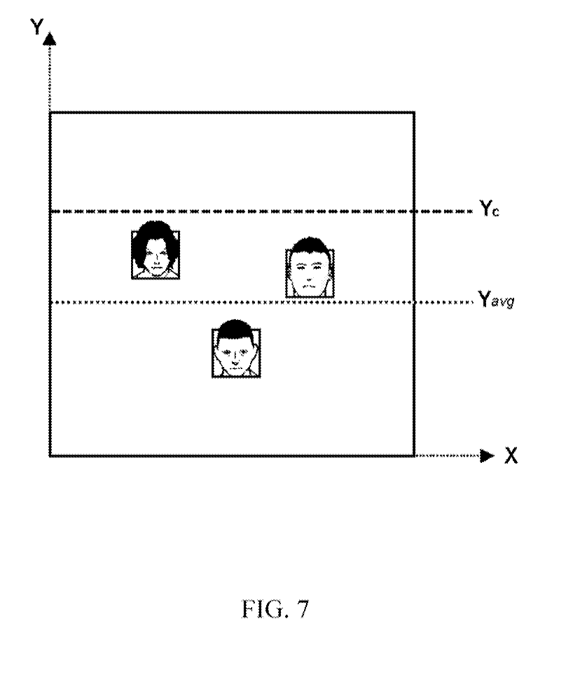

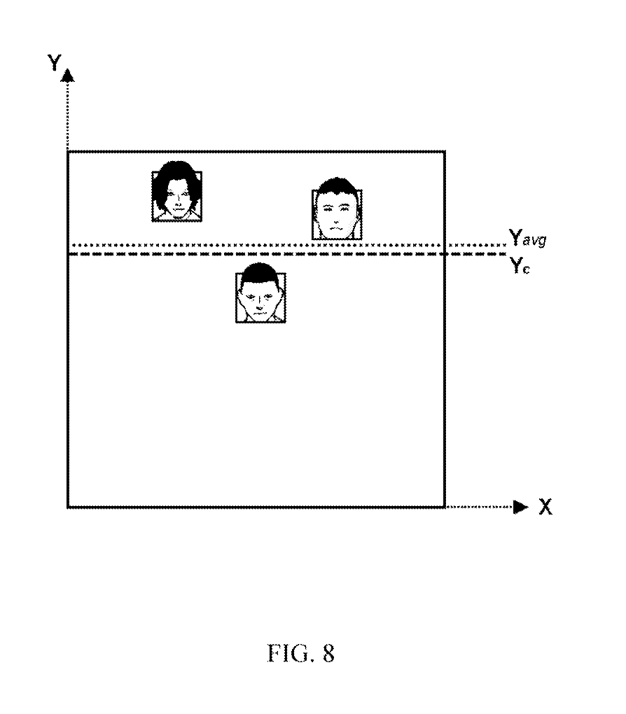

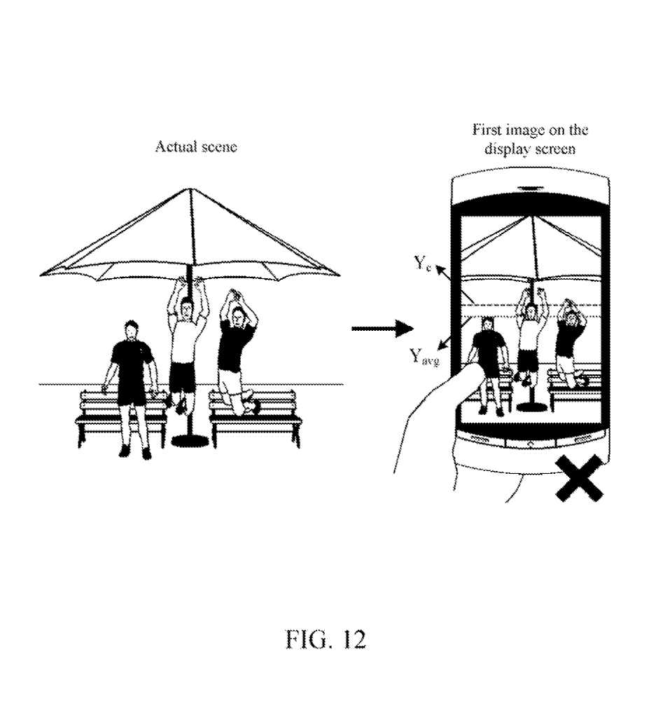

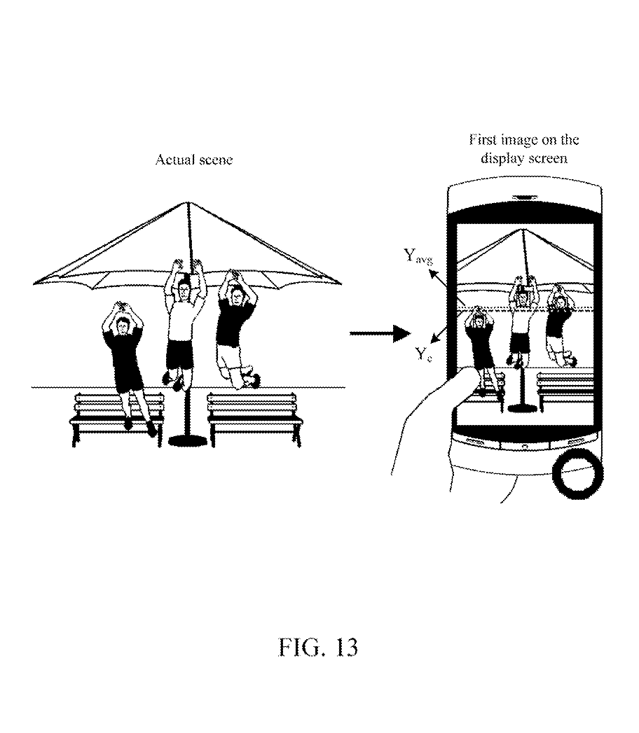

In step S14, the face analyzing module 243 compares the average value “Y_{avg}” of the Y-axis coordinates of the center points with a preset Y-axis coordinate “Yc” corresponding to the preset reference line, and determines whether the average value “Y_{avg}” is greater than the preset Y-axis coordinate “Yc”. If the average value “Y_{avg}” is less than or equal to the preset Y-axis coordinate “Yc” (refers to FIG. 7 and FIG. 12), the face analyzing module 243 determines that someone does not jump in the first image, the procedure returns to step S10. If the average value “Y_{avg}” is greater than the preset Y-axis coordinate “Yc” (refers to FIG. 8 and FIG. 13), the face analyzing module 243 determines that all of people have jumped in the first image, the procedure goes to step S15. That is, the face analyzing module 243 determines whether all of people have jumped according to the positions (e.g. the Y-axis coordinates) of the face areas of the people in the first image.

In step S15, the control module 244 controls the image capturing device 20 to capture a second image, and displays the second image on the display screen 22. For example, the control module 244 controls the image capturing device 20 to capture the second image by activating a shutter of the image capturing device 20. In one embodiment, the second image is an optimized image in which all of people have jumped.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for capturing an optimized image of people jumping, the method comprising:
obtaining a first image captured by an image capturing device of an electronic device;
detecting face areas from the first image;
obtaining vertical coordinates of center points of the detected face areas, and calculating an average value of the vertical coordinates of the center points; and
controlling the image capturing device to capture a second image when the calculated average value is greater than a preset value, the second image being determined as the optimized image that all of people in the second image have jumped.

2. The method according to claim 1, further comprising: presetting a reference line on a display screen of the electronic device, and determining a vertical coordinate of the preset reference line.

3. The method according to claim 2, wherein the preset value is determined to be the vertical coordinate of the preset reference line.

4. The method according to claim 1, wherein the face areas are detected from the first image using an skin color model in YCbCr space.

5. The method according to claim 1, wherein the face areas are detected from the first image using a face template matching method.

6. An electronic device, comprising:
a processor;
a storage device storing a plurality of instructions, which when executed by the processor, causes the processor to:
obtain a first image captured by an image capturing device of the electronic device;
detect face areas from the first image;
obtain vertical coordinates of center points of the detected face areas, and calculate an average value of the vertical coordinates of the center points; and
control the image capturing device to capture a second image when the calculated average value is greater than a preset value, the second image being determined as an optimized image that all of people in the second image have jumped.

7. The electronic device according to claim 6, wherein the plurality of instructions further comprise: presetting a reference line on a display screen of the electronic device, and determining a vertical coordinate of the preset reference line.

8. The electronic device according to claim 7, wherein the preset value is determined to be the vertical coordinate of the preset reference line.

9. The electronic device according to claim 6, wherein the face areas are detected from the first image using an skin color model in YCbCr space.

10. The electronic device according to claim 6, wherein the face areas are detected from the first image using a face template matching method.

11. A non-transitory storage medium having stored thereon instructions that, when executed by a processor of an electronic device, causes the electronic device to perform a method for capturing an optimized image of people jumping, the method comprising:
obtaining a first image captured by an image capturing device of the electronic device;
detecting face areas from the first image;
obtaining vertical coordinates of center points of the detected face areas, and calculating an average value of the vertical coordinates of the center points; and
controlling the image capturing device to capture a second image when the calculated average value is greater than a preset value, the second image being determined as the optimized image that all of people in the second image have jumped.

12. The non-transitory storage medium according to claim 11, wherein the method further comprises: presetting a reference line on a display screen of the electronic device, and determining a vertical coordinate of the preset reference line.

13. The non-transitory storage medium according to claim 12, wherein the preset value is determined to be the vertical coordinate of the preset reference line.

14. The non-transitory storage medium according to claim 11, wherein the face areas are detected from the first image using an skin color model in YCbCr space.

15. The non-transitory storage medium according to claim 11, wherein the face areas are detected from the first image using a face template matching method.
